(19) United States
(12) Patent Application Publication
(10) Pub. No.: US 2018/0358666 A1
(43) Pub. Date: Dec. 13, 2018

(54) Battery Cell Module Having a Cooling Element

(71) Applicant: Bayerische Motoren Werke Aktiengesellschaft, Muenchen (DE)

(72) Inventors: Sebastian SIERING, Muenchen (DE); Florian LANDERER, Grafing (DE); Fabian BURKART, Muenchen (DE); Florian EINOEGG, Muenchen (DE); Christoph KLAUS, Oberschleissheim (DE); Daniel SCHERER, Muenchen (DE); Tuncay IDIKURT, Muenchen (DE)

(21) Appl. No.: 16/104,225

(22) Filed: Aug. 17, 2018

Related U.S. Application Data
(63) Continuation of application No. PCT/EP2017/050839, filed on Jan. 17, 2017.

(30) Foreign Application Priority Data
Feb. 17, 2016 (DE) 10 2016 202 375.6

(51) Int. Cl. H01M 10/613; H01M 2/10; H01M 10/6554; H01M 10/625; H01M 10/6551

(52) U.S. Cl. CPC H01M 10/613; H01M 2/1094; B60L 11/1874; H01M 10/625; H01M 10/6551; H01M 10/6554

(57) ABSTRACT

A battery cell module, in particular for a motor vehicle, includes a first battery cell package having at least one battery cell, which has a first cooler connection surface, and a cooling element intended for cooling of the first battery cell package. The cooling element has a first cooling surface facing the first cooler connection surface. The battery cell module is characterized in that a first voltage-insulating layer and/or a first thermally conducting layer is or are arranged between the first cooler connection surface and the first cooling surface, forming a direct, cohesive connection of the first cooler connection surface to the first cooling surface.

### CROSS REFERENCE TO RELATED APPLICATIONS

This application is a continuation of PCT International Application No. PCT/EP2017/050839, filed Jan. 17, 2017, which claims priority under 35 U.S.C. § 119 from German Patent Application No. 10 2016 202 375.6, filed Feb. 17, 2016, the entire disclosures of which are herein expressly incorporated by reference.

### BACKGROUND AND SUMMARY OF THE INVENTION

The invention relates to a battery cell module of an energy store of a vehicle having a cooling element, and a method for producing such a battery cell module.

Battery cell modules are installed in electric and hybrid vehicles. These battery cell modules consist of a plurality of battery cells which are usually stacked to form battery cell stacks and clamped and held in shape by a frame. The frame includes an apparatus for fixing it to an energy store housing.

The battery cell module is usually provided with base cooling by way of a so-called heat-conducting plate in order to dissipate thermal energy, so that the battery cell module does not exceed a defined maximum operating temperature. In this case, cooling can be performed by a medium or a fluid which flows through cooling elements. In particular, interlocking or force-fitting connections are used between cooling elements and heat-conducting plates of battery cell modules, wherein the heat-conducting plates are adhesively bonded, for example, to the battery cell modules.

In order to minimize a thermally insulating layer of air which is present between cooling elements and heat-conducting plates and, as a result, to improve the transmission of heat between these elements, these elements are pressed against one another with a high force. The required force can be exerted, for example, by spring rails. This force has an effect on the heat output which can be dissipated, in particular in the case of uneven cooling elements, heat-conducting plates or battery cell modules (that is to say when there is a distance between the housing and the battery cell module) or housings (owing to the spring rails). In addition, the spring rails are subject to aging, so that the contact-pressure effect and, therefore, the achievable transmission of heat drops as the age of the battery cell module increases.

In addition to high contact-pressure forces being exerted by the spring rails, high standards are set in respect of cleanliness during manufacture in order to minimize impurities at the boundary surface between the cooling element and the heat-conducting plate. This is particularly necessary in order to avoid air pockets.

Therefore, particularly stiff elements and also additional steps are required during production, in particular when inserting, centering and holding down cooling and pressing elements, wherein the cooling elements are particularly sensitive. This leads to cost-intensive production and an increase in the mass of the components of the battery cell module. The overall performance cannot be extended as desired without adjusting the operating parameters to a considerable extent.

The invention is therefore based on the object of providing a battery cell module and also a method for producing said battery cell module, wherein the battery cell module is intended to be produced in a simple and cost-effective manner and ensure high-level and reliably functioning dissipation of heat over its entire service life.

This object is achieved by a battery cell module and by a production method in accordance with embodiments of the invention.

A battery cell module according to the invention, which is intended, in particular, for the energy store of a motor vehicle, comprises a first battery cell package comprising at least one battery cell which has a first cooler connection surface, and a cooling element which is intended for cooling the first battery cell package and has a first cooling surface which faces the first cooler connection surface. A first voltage-insulating layer and/or a first heat-conducting layer are/is arranged between the first cooler connection surface and the first cooling surface so as to form a direct cohesive connection between the first cooler connection surface and the first cooling surface.

In this case, the expression “cohesive” means that at least one of the abovementioned layers is in the form of a bonding or adhesive layer and, therefore, the entire arrangement comprising battery cell package, cooling elements and said layers constitutes a fixedly connected unit which does not require any further elements, as are represented by the spring rails mentioned in the introductory part for example, to hold this arrangement together. The term “directly” is intended to be understood to mean that no layers other than said layers between the respective cooler connection surface and the cooling surface are present. If an adhesive which is used for fixing the voltage-insulating layer to the cooler connection surface or the cooling surface is present, said adhesive—even if it is present as a complete “layer”—is not to be regarded as a separate, further layer, but rather as belonging to the voltage-insulating layer as an integral constituent part. The same applies for any adhesive which may be present on the heat-conducting layer. The term “heat-conducting” is intended to be understood to mean that the layer in question has a degree of thermal conductivity which is high enough for the required intended use. The same applies to the term “voltage-insulating” in respect of the capability to insulate against an electrical voltage between the battery cell module and the cooling element. The required dimensioning of the insulation capability and the thermal conductivity is clear to a person skilled in the art and therefore this does not have to be discussed any further.

Owing to the cohesive and direct connection, the battery cell module according to the invention can firstly be produced in a cost-effective manner, since for one thing only simple method steps and no additional components, such as spring rails for example, are required, and secondly the connection which is established in this way is permanent—that is to say over the entire service life of the battery cell module. Therefore, according to the invention, mechanical and thermal connection of the battery cell module to the cooling element is achieved at the same time owing to the cohesive and direct connection.

The battery cell module according to the invention has the advantage that no heat-conducting plate and no spring rails are required. Firstly, the number of elements required is reduced, so that economical production of the battery cell module is made possible. Secondly, the mass of the battery cell module is reduced.

In addition, no pressure is exerted on the battery cell module by any spring elements, so that a high degree of stiffness of the installed elements is not necessary.

Furthermore, the cooling unit is integrated in the battery cell module, so that direct dissipation of the thermal energy is made possible.

According to one advantageous embodiment, the first voltage-insulating layer is in the form of a bonding or adhesive layer. Therefore, said first voltage-insulating layer does not have to be separately provided with an adhesive.

It is advantageous when the first heat-conducting layer is in the form of a bonding or adhesive layer, because no separate application of adhesive is required in this case either.

According to a further advantageous embodiment, the first voltage-insulating layer comprises a high-voltage-insulating film or consists exclusively thereof. This simplifies production since a film of this kind is easy to process.

The first heat-conducting layer comprises a heat-conducting potting compound and/or a heat-conducting adhesive or even consists completely thereof. As a result, production can be simplified and therefore be cost-effective and also a very high degree of tolerance compensation between the cooling surface and the cooler connection surface can be achieved. Also, the effective surface for the transfer of heat can be maximized if the surfaces are not completely planar or provided with roughened portions.

Advantages in respect of good connection of the layer structure can be provided when a further heat-conducting layer is arranged between the first cooler connection surface and the first cooling surface.

According to the invention, a twin battery cell module can be formed by a second battery cell package being provided, said second battery cell package being arranged, as it were, in a mirror-inverted manner with respect to the first battery cell package, wherein the center plane of the cooling element constitutes the plane of symmetry. The heat-conducting path is optimized in this twin battery cell module since two battery cell packages can be cooled using a single cooling element.

By producing the battery cell module according to the inventive method, the production costs can be reduced since the individual steps can be executed without a great deal of technical expenditure and fewer components are required. In particular, no spring elements—which permanently remain on the battery cell module—which would create additional costs are required, but rather a step of pressing or compressing the entire arrangement has to be executed only once in order to achieve permanent stability.

According to one advantageous embodiment, battery cell packages are mounted on each of the two main sides of a cooling element (more or less with mirror-image symmetry), as a result of which a twin battery cell module can be produced.

When, during production of the battery cell module according to the invention, the heat-conducting compound is suitably applied respectively in the form of a defined pattern, in particular a meandering, wave-like or zigzag pattern, or in the form of a plurality of—possibly parallel—stripes, preferably in the form of a raised bead, a thin layer can be created by subsequently pressing the pattern. This thin layer firstly bonds well and, if air pockets are avoided or eliminated, secondly also is highly heat-conducting. If the heat-conducting compound is designed such that it provides very good electrical insulation, a separate voltage-insulating layer can furthermore be dispensed with.

The defined pattern application in the form of heat-conducting potting compound serves for subsequent distribution of the heat-conducting potting compound in this case. Therefore, uniform application of this compound is necessary, so that a surface which is as planar as possible and compensates for the tolerances of the battery cell package is produced. In addition, it is made possible in this way for air which is included between a battery cell package surface and a heat-conducting potting compound layer, and also between a heat-conducting potting compound layer and a high-voltage-insulating layer, to escape. This leads to a cohesive, that is to say both mechanical and thermal, connection and to tolerance compensation. It also leads to maximization of the effective connecting and transfer surface between a battery cell packet and a cooling element.

In particular, simple tolerance compensation and a robust design of the cooling plate prevent damage during manufacture of the battery cell module. A reduction in costs and weight is achieved owing to the omission of clamping elements, such as spring rails.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a side view of a first embodiment of a battery cell module according to the invention.

FIG. 2 is a plan view of a heat-conducting potting compound which is applied to a high-voltage-insulating film as a bead according to, for example, the first embodiment of a cooling apparatus of the battery cell module according to the present invention even before pressing.

FIGS. 3A to 3J are lateral cross sections through the first embodiment of the battery cell module according to the present invention.

FIGS. 4A to 4D are lateral cross sections through a second embodiment of the battery cell module according to the present invention.

### DETAILED DESCRIPTION OF THE DRAWINGS

Preferred embodiments of the battery cell module according to the invention are described with reference to the figures.

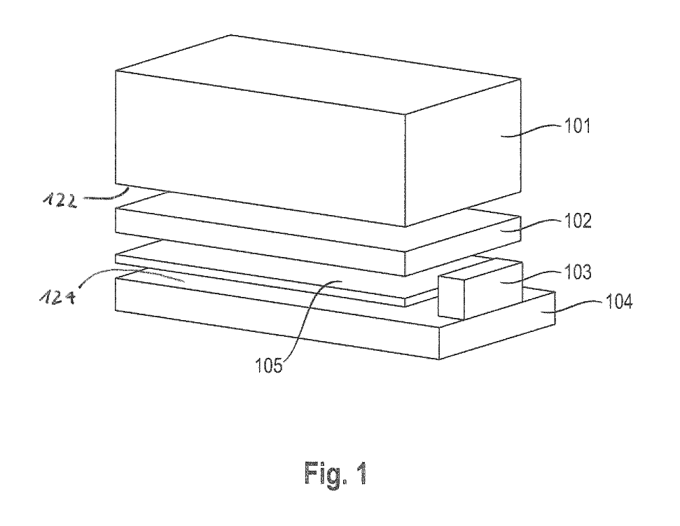

FIG. 1 shows a side view of a first embodiment of the battery cell module according to the invention, wherein a battery cell package 101, which has a stack of battery cells, are connected to a cooling element, which is in the form of a cooling plate 104, over one of its surfaces by a heat-conducting potting compound layer 102 as a heat-conducting layer and a high-voltage-insulating layer 105 as a voltage-insulating layer. In this case, the heat-conducting potting compound layer 102 is bonded to the lower surface of the battery cell package 101, which lower surface constitutes a first cooler connection surface 122, while the high-voltage-insulating layer 105 is bonded to the upper surface of the cooling plate 104, which upper surface serves as a cooling surface 124. Therefore, a cohesive connection is achieved between the battery cell package 101 and the cooling plate 104 by direct bonding.

The cooling plate 104 can selectively be provided with fluid channels which are formed therein. In this case, the cooling plate 104 can be provided with a fluid connecting flange 103 in an edge region, said fluid connecting flange being configured to supply and/or discharge a fluid to/from the cooling plate 104. As an alternative, flat pipes or multi-ports having a soldered or adhesively bonded plate which act as a cooling element 104 can be used.

The following method steps are carried out in order to form a battery module according to the first embodiment.

Firstly, a surface of the cooling plate 104 is cleaned and/or activated, wherein, for example, washing in ethanol and/or plasma treatment can be carried out.

The self-bonding high-voltage-insulating layer 105 is then adhesively bonded onto this cleaned surface. Cleaning serves, in particular, to clean the surface of all foreign molecules which can lead to bubbles being formed. In addition, the surface can be activated, in order to increase the bonding of the high-voltage-insulating layer 105.

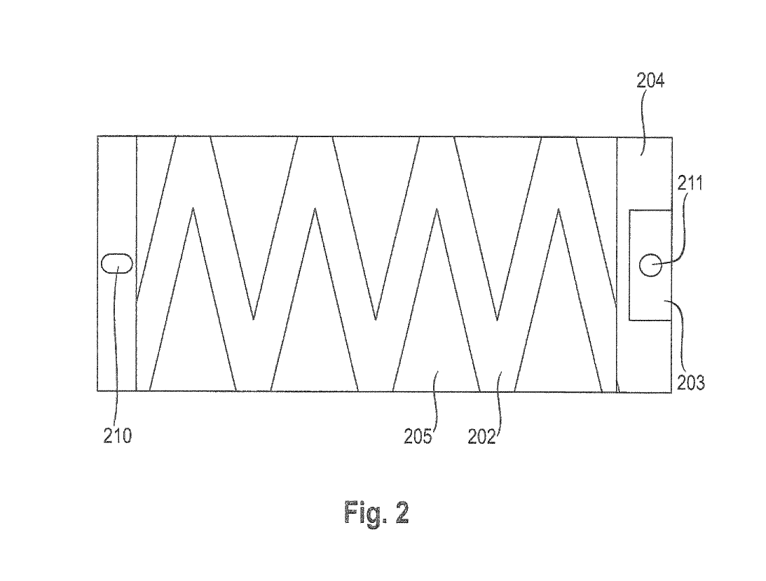

Next, the heat-conducting potting compound layer 102 is applied to the high-voltage-insulating layer 105. In the process, the heat-conducting potting compound layer 102 is preferably applied in the form of a defined pattern. A zigzag pattern is shown in plan view in FIG. 2. As an alternative, a different pattern can also be selected for the application. This pattern application serves to provide as uniform a distribution as possible of the heat-conducting potting compound layer 102 as a thin layer on the high-voltage-insulating layer 105 when the battery cell package 101 is subsequently fitted. The defined pattern application therefore leads to the heat-conducting potting compound layer 102 on the high-voltage-insulating layer 105 which allows cohesive mechanical and thermal connection, tolerance compensation between the battery cell package 101 and the cooling plate 104, and also to maximization of the effective connecting or transfer surface.

In order to be able to fit the battery cell package 101 onto the heat-conducting potting compound layer 102 in a controlled manner, an elongate hole 210 and a centering hole 211 are arranged opposite one another in the edge region of the shorter sides of the cooling plate 104 in such a way that corresponding centering elements (not shown) on a housing of the battery cell package 101 can be inserted into the elongate hole 210 and the centering hole 211. Therefore, the battery cell package and the cooling element are pressed in a centered manner.

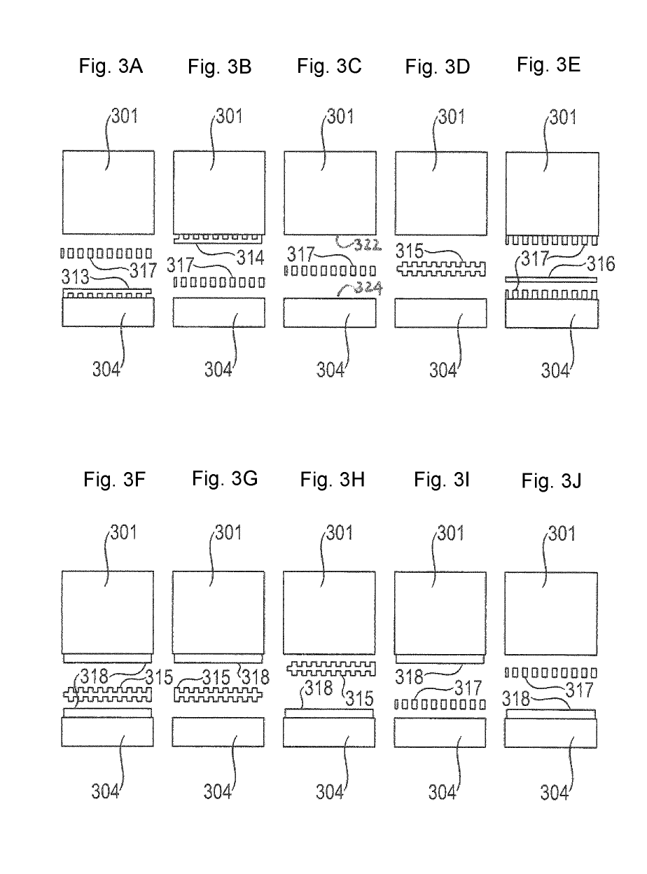

FIGS. 3A to 3J show lateral cross sections through the first embodiment of the battery cell module according to the invention and modifications thereto, wherein the respective structure is described from top to bottom.

FIG. 3A shows a sequence of a battery cell package 301, a bonding heat-conducting potting compound layer 317 which has not yet been cured, that is to say does not yet have a bonding effect, and is bonded to the lower surface of the battery cell package 301, and also a high-voltage-insulating layer 313 which is self-bonding at the bottom and is bonded to the upper surface of the cooling plate 304 and has an electrically insulating effect. Both the bonding heat-conducting potting compound layer 317 and also the high-voltage-insulating layer 313 which is self-bonding at the bottom are provided as elements which transmit thermal energy.

FIG. 3B shows a sequence of the battery cell package 301, a high-voltage-insulating layer 314 which is self-adhesive at the top and is bonded to the lower surface of the battery cell package 301 and provides electrical insulation, and the bonding heat-conducting potting compound layer 317 which is bonded to the upper surface of the cooling plate 304.

FIG. 3C shows a sequence of the battery cell package 301, the heat-conducting potting compound layer 317 which is bonded to a first cooler connection surface 322 of the battery cell package 301 and also to a first cooling surface 324 of the cooling plate 304, and the cooling plate 304. For reasons of better clarity, the cooler connection surface 322 and the cooling surface 324 are not specifically illustrated in FIGS. 3A, 3B and 3D to 3J. In particular, when completely bubble-free assembly is achieved, so that there are no air bubbles between the battery cell package 301, the bonding heat-conducting potting compound layer 317 and the cooling plate 304, the bonding heat-conducting potting compound layer 317 also has an electrically insulating effect, so that use of a high-voltage-insulating layer is dispensed with.

FIG. 3D shows a sequence of the battery cell package 301, a double-sidedly self-bonding high-voltage-insulating layer 315, and the cooling plate 304. Here, the self-bonding high-voltage-insulating layer 315 ensures both bonding of the battery cell package 301 to the cooling plate 304 and also electrical insulation.

FIG. 3E shows a sequence of the battery cell package 301, the bonding heat-conducting potting compound layer 317, the non-self-bonding high-voltage-insulating layer 316, the bonding heat-conducting potting compound layer 317, and the cooling plate 304. The bonding heat-conducting potting compound layer 317 respectively ensures bonding between the battery cell package 301 and the non-self-bonding high-voltage-insulating layer 316 and also between the non-self-bonding high-voltage-insulating layer 316 and the cooling plate 304, while the non-self-bonding high-voltage-insulating layer 316 ensures electrical insulation.

FIG. 3F shows a sequence of the battery cell package 301, a cured heat-conducting potting compound layer 318 which does not have a bonding effect, the double-sidedly self-bonding high-voltage-insulating layer 316, a further cured heat-conducting potting compound layer 318, and the cooling plate 304. The double-sidedly self-bonding high-voltage-insulating layer 316 ensures both bonding and also electrical insulation.

One of the cured heat-conducting potting compound layers 318 can selectively be omitted, as shown in FIGS. 3G and 3H.

FIG. 3I shows a sequence of the battery cell package 301, the cured heat-conducting potting compound layer 318, the bonding heat-conducting potting compound layer 317, and the cooling plate 304. As in the case of the structure shown in FIG. 3C, completely bubble-free assembly has to be achieved for this purpose, so that there are no air bubbles between the battery cell package 301, the heat-conducting potting compound layers 317 and 318 and the cooling plate 304. Only then do the heat-conducting potting compound layers 317 and 318 have an electrically insulating effect.

FIG. 3J shows a sequence of the battery cell package 301, the bonding heat-conducting potting compound layer 317, the cured heat-conducting potting compound layer 318, and the cooling plate 304. In this case too, the heat-conducting potting compound layers 317 and 318 have an electrically insulating effect only when as far as possible no air bubbles have been included.

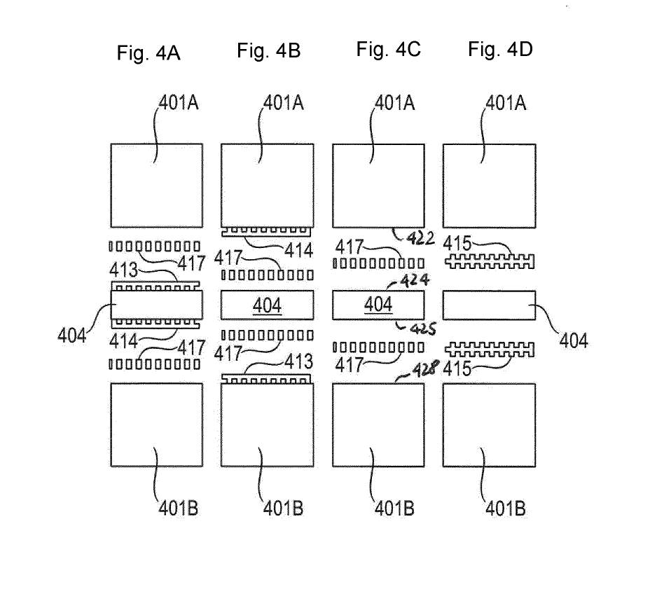

FIGS. 4A to 4D show lateral cross sections through the second embodiment of the battery cell module according to the invention and modifications thereto, wherein the respective structure is described from top to bottom.

FIG. 4A shows a battery cell module which has a battery cell package 401A, a bonding heat-conducting potting compound layer 417, a high-voltage-insulating layer 413 which is self-bonding at the bottom, a cooling plate 404, a high-voltage-insulating layer 414 which is self-bonding at the top, a further bonding heat-conducting potting compound layer 417, and a battery cell package 401B. Therefore, a structure which is reflected (mirror image) with respect to the cooling plate 404 is provided. Therefore, two battery cell packages 401A and 401B can be cooled by one cooling plate 404, so that less installation space and an optimized heat-conducting path are achieved. Bonding between the individual components is performed by the bonding heat-conducting potting compound layers 417, while the insulating effect is made possible by the self-bonding high-voltage-insulating layers 413 and 414.

FIG. 4B shows a sequence of the components which is modified in comparison to FIG. 4A: the battery cell package 401A, the high-voltage-insulating layer 414 which is self-bonding at the top, the bonding heat-conducting potting compound layer 417, the cooling plate 404, the further bonding heat-conducting potting compound layer 417, the high-voltage-insulating layer 413 which is self-bonding at the bottom, and the battery cell package 401B.

The self-bonding high-voltage-insulating layers 413 and 414 which are known from FIGS. 4A and 4B are omitted from FIG. 4C. This is possible particularly when completely bubble-free assembly is achieved, so that there are no air bubbles between the battery cell package 401A and 401B, the heat-conducting potting compound layer 417 which is bonded at the top to a first cooler connection surface 422 of the battery cell package 401A and also at the bottom to a first cooling surface 424 of the cooling plate 404, and a further heat-conducting potting compound layer 417 which is bonded at the top to a second cooling surface 425 of the cooling plate 404 and also at the bottom to a second cooler connection surface 428 of the battery cell package 401B, and the cooling plate 404. In this case, the bonding heat-conducting potting compound layers 417 have an electrically insulating effect, so that use of a high-voltage-insulating layer is dispensed with. Once again for reasons of better clarity, the cooler connection surfaces 422 and 428 and also the cooling surfaces 424 and 425 are not specifically illustrated in FIGS. 4A, 4B and 4D.

FIG. 4D shows a battery cell module which has the battery cell package 401A, a double-sidedly self-bonding high-voltage-insulating layer 415, the cooling plate 404, a further double-sidedly self-bonding high-voltage-insulating layer 415, and the battery cell package 401B. In this case, the double-sidedly self-bonding high-voltage-insulating layers 415 respectively ensure bonding between the battery cell packages 401A and 401B and the cooling plate 404.

It goes without saying that in the present invention there is a relationship between firstly features which have been described in connection with method steps and also secondly features which have been described in connection with corresponding apparatuses. Therefore, described method features are also to be considered to be apparatus features which belong to the invention—and vice versa—even if this has not been explicitly stated.

It should be noted that the features of the invention described with reference to the illustrated embodiments, such as for example layers and surfaces (and also the type and configuration thereof and the arrangement of the individual components relative to one another or the sequence of the respective method steps) can also be present in other embodiments or variants thereof, unless stated otherwise or automatically ruled out for technical reasons. In addition, all of the features from amongst features of this kind, described in combination, of individual embodiments do not necessarily always have to be realized in a respective embodiment.

### LIST OF REFERENCE SYMBOLS

101 Battery cell package

102 Heat-conducting potting compound

103 Fluid connecting flange

104 Cooling plate

105 High-voltage-insulating layer

122 Cooler connection surface

124 Cooling surface

202 Patterned heat-conducting potting compound

203 Fluid connecting flange

204 Cooling plate

205 High-voltage-insulating layer

210 Elongate hole

211 Centering hole

301 Battery cell package

304 Cooling plate

313 High-voltage-insulating layer which is self-bonding at the bottom

314 High-voltage-insulating layer which is self-bonding at the top

315 Double-sidedly self-bonding high-voltage-insulating layer

316 Non-self-bonding high-voltage-insulating layer

317 Bonding heat-conducting potting compound layer

318 Cured heat-conducting potting compound layer

322 Cooler connection surface

324 Cooling surface

401A, 401B Battery cell package

404 Cooling plate

413 High-voltage-insulating layer which is self-bonding at the bottom

414 High-voltage-insulating layer which is self-bonding at the top

415 Double-sidedly self-bonding high-voltage-insulating layer

417 Bonding heat-conducting potting compound layer

422 First cooler connection surface

424 First cooling surface

425 Second cooling surface

428 Second cooler connection surface

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A battery cell module, comprising:
a first battery cell package comprising at least one battery cell which has a first cooler connection surface; a cooling element for the first battery cell package having a first cooling surface which faces the first cooler connection surface; and
a first voltage-insulating layer and/or a first heat-conducting layer arranged between the first cooler connection surface and the first cooling surface so as to form a direct cohesive connection between the first cooler connection surface and the first cooling surface.

2. The battery cell module as claimed in claim 1, wherein
the first voltage-insulating layer is formed as a bonding or adhesive layer.

3. The battery cell module as claimed in claim 2, wherein
the first heat-conducting layer is formed as a bonding or adhesive layer.

4. The battery cell module as claimed in claim 1, wherein
the first heat-conducting layer is formed as a bonding or adhesive layer.

5. The battery cell module as claimed in claim 1, wherein
the first voltage-insulating layer comprises a high-voltage-insulating film.

6. The battery cell module as claimed in claim 1, wherein
the first heat-conducting layer comprises a heat-conducting potting compound and/or a heat-conducting adhesive.

7. The battery cell module as claimed in claim 1, further comprising:
a further heat-conducting layer arranged between the first cooler connection surface and the first cooling surface so as to form the direct cohesive connection between the first cooler connection surface and the first cooling surface.

8. The battery cell module as claimed in claim 1, further comprising:
a second battery cell package comprising at least one battery cell which has a second cooler connection surface, wherein
the cooling element has a second cooling surface, and
a second voltage-insulating layer and/or a second heat-conducting layer arranged between the second cooler connection surface and the second cooling surface so as to form a direct cohesive connection between the second cooler connection surface and the second cooling surface.

9. The battery cell module as claimed in claim 1, wherein the battery cell module is a motor vehicle battery cell module.

10. A method for producing a battery cell module, the method comprising the steps of:
a) providing a cooling element which has a first cooling surface on a top side;
b) fixing a first voltage-insulating layer on the first cooling surface;
c) applying a heat-conducting compound onto the first voltage-insulating layer;
d) mounting a first battery cell package, which has a first cooler connection surface, onto the first voltage-insulating layer, wherein the first cooler connection surface faces the first cooling surface; and
e) pressing the cooling element, the first voltage-insulating layer, the heat-conducting compound and the first battery cell package in a direction which is substantially perpendicular to the first cooling surface so as to form a direct cohesive connection between the first cooler connection surface and the first cooling surface.

11. The method as claimed in claim 8, further comprising the steps of:
f) providing a second battery cell package which has a second cooler connection surface on a top side;
g) applying a heat-conducting compound onto the second cooler connection surface;
h) fixing a second voltage-insulating layer on a second cooling surface which is provided on that side of the cooling element which is averted from the first cooling surface; and
i) arranging the second battery cell package with its second cooler connection surface and the second heat-conducting compound on the cooling element so that the second cooler connection surface faces the second cooling surface;
wherein, in step e), the arrangement which is formed in step i) is pressed for forming an additional direct cohesive connection between the second cooler connection surface and the second cooling surface.

12. The method as claimed in claim 10, wherein
the heat-conducting compound is applied in the form of a defined pattern.

13. The method as claimed in claim 12, wherein the defined pattern is one of a meandering patter, a zigzag pattern or a plurality of stripes pattern.

14. A battery cell module of a motor vehicle, consisting essentially of:
a first battery cell package comprising at least one battery cell having a first cooler connection surface;
a cooling element that cools the first battery cell package, the cooling element having a first cooling surface facing the first cooler connection surface; and
a layer arranged between the first cooler connection surface and the first cooling surface so as to form a direct cohesive connection between the first cooler connection surface and the first cooling surface.

15. The battery cell module as claimed in claim 14, wherein the layer is a voltage-insulating layer.

16. The battery cell module as claimed in claim 14, wherein the layer is a heat-conducting layer.

17. The battery cell module as claimed in claim 15, wherein a further layer is a heat-conducting layer.
